(19) United States
(12) Patent Application Publication
(10) Pub. No.: US 2001/0013013 A1
(43) Pub. Date: Aug. 9, 2001

(54) Advertisement display system in map-information providing service

(75) Inventor: Takashi Takenaga, Tokyo (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: Pioneer Corporation; Increment P Corporation

(21) Appl. No.: 09/775,574

(22) Filed: Feb. 5, 2001

(30) Foreign Application Priority Data
Feb. 4, 2000 (JP) 2000-28172

(51) Int. Cl. G06F 17/60

(52) U.S. Cl. 705/14

(57) ABSTRACT

An advertisement site (S3) displaying advertisements on a map image (M) displayed on a user terminal (T) includes a advertisement server (S3a) for displaying a route setting and advertisements situated along the set route (R) on the map image (M), a route database (3Sb) storing road data on a map required for setting a route in the advertisement server (3Sa), and an advertisement database (S3c) storing registered advertisement data. The advertisement server (3Sa) sets a route based on the road data stored in the route database (3Sb), and reads out advertisements situated along the set route from the advertisement database (3Sc) to display them on the user terminal (T).

### BACKGROUND OF THE INVENTION

1. Field of the Invention

The invention relates to a system for displaying an advertisement on a map image displayed on a user terminal through a computer network.

2. Description of the Related Art

In recent years, map-information providing services for retrieving map-information in a map-information providing server connected to a computer network for a user have achieved widespread use with the establishment of information retrieval devices such as microcomputers and the rapid growth of information providing services via the computer network, e.g. Internet.

Such a map-information providing service transmits map-image data of a desired area read from a database in a map-information provider server to a user terminal via the computer network to display a map image based on the map-image data thereon.

Recognition of the importance of the utility of such a map-information providing service as advertising media grows with increase in commercial exploitation of the map-information providing service. The map-information providing service approaches increase in utility as advertising media and the providing of information to users by means of registering advertisers and displaying an advertisement of the registered advertiser on the map images.

In conventional map-information providing services, however, when advertisements are displayed on the map image displayed on the user terminal, as illustrated in FIG. 4, all the advertisements registered in an area of the displayed map image M are displayed.

Therefore, the frame of the map image M is filled with icons C indicating advertisements, or the user hardly finds or overlooks a necessary advertisement because of the displayed advertisements which are not very useful to the user. This produces a problem in that the possibility of effective use of the service may be rare.

### SUMMARY OF THE INVENTION

The present invention has been made for solving the problems arising when advertisements are displayed on a map image displayed in the conventional map-information providing service as described above.

It is therefore an object of the present invention to allow users to further effectively use advertisements on a map image displayed by a map-information providing service.

To attain the above object, an advertisement display system in a map-information providing service according to a first invention transmits map-image data to a user terminal to display a map image based on the map-image data and displays advertisements on the displayed map image. Such advertisement display system in a map-information providing service features in that an advertisement site for displaying the advertisements on the map image displayed on the user terminal, including a advertisement server for displaying a route setting and advertisements situated along the set route on the map image, a route database storing road data on a map required for setting a route in the advertisement server, and advertisement database storing registered advertisement data, in which the advertisement server sets a route based on the road data stored in the route database, and read advertisements situated along the set route from the advertisement database to display them on the user terminal.

In the advertisement display system in a map-information providing service according to the first invention, the advertisement server of the advertisement site sets a route matching the conditions specified by the user (e.g. a shortest route) based on the road data stored in the route database in accordance with the route setting conditions specified on the user terminal. After that, the advertisement server reads out the advertisement data of the advertisements situated along the set route from the advertisement database, and then displays the advertisements based on the read advertisement data, and the set route on the map image on the user terminal.

According to the first invention, therefore, the number of advertisements displayed on the map screen displayed on the user terminal is reduced in comparison with that in the conventional system. Since the only advertisements situated along the route through which the user is going to pass, it is possible for the user to immediately find and use useful advertisements.

To attain the above object, the advertisement display system in a map-information providing service according to a second invention features in addition to the configuration of the first invention in that the advertisement server reads out only advertisements matching a profile of a user of the advertisements situated along the set route from the advertisement database based on the data representing the profile of the user sent from the user terminal, and displays them on the user terminal.

In the advertisement display system in a map-information providing service of the second invention, if the user enters the route setting conditions and also his/her profile such as a sex, age, and favorites on the user terminal, when the advertisement server of the advertisement site reads out the advertisement data of the advertisements situated along the set route from the advertisement database, the advertisements matching the user's profile, for example, only advertisement data of boutiques, cosmetics stores and so on if the user is a young woman, is further selected and read out from the advertisement data of the advertisements situated along the set route, based on the entered user's profile, and displays them along the set route on the map image.

Thus, since the advertisements to be displayed along the set route on the map image on the user terminal are selected based on the user's profile, the only advertisements more useful to the user are displayed on the map image.

To attain the above object, the advertisement display system in a map-information providing service according to a third invention features in addition to the configuration of the first invention in that the advertisement site further includes a user registration database storing registration data representing the profile of the user, wherein the advertisement server reads out only the advertisement, matching the profile of the user of the advertisements situated along the set route, from the advertisement database based on the registration data of the user readout from the user registration database, and displays them on the user terminal.

In the advertisement display system in a map-information providing service of the third invention, when the advertisement server of the advertisement site reads out the advertisement data of the advertisements situated along the set route from the advertisement database, the advertisements matching the user's profile, for example, only advertisement data of boutiques, cosmetics stores and so on if the user is a young woman, of the advertisements situated along the set route is selected and read based on the registered data of the user read out from the user registration database, and displays them along the set route on the map image.

Thus, since the advertisements to be displayed along the set route on the map image on the user terminal are selected based on the user's profile, the only advertisements more useful to the user are displayed on the map image.

These and other objects and advantages of the present invention will become obvious to those skilled in the art upon review of the following description, the accompanying drawings and appended claims.

### BRIEF DESCRIPTION OF THE DRAWINGS

FIG. 1 is a system block diagram showing an example of an embodiment according to the present invention.

FIG. 2 is an explanatory diagram showing a display example of advertisements in the example.

FIG. 3 is an explanatory diagram showing another display example of advertisements in the example.

FIG. 4 is an explanatory diagram showing a display example of advertisements in prior art

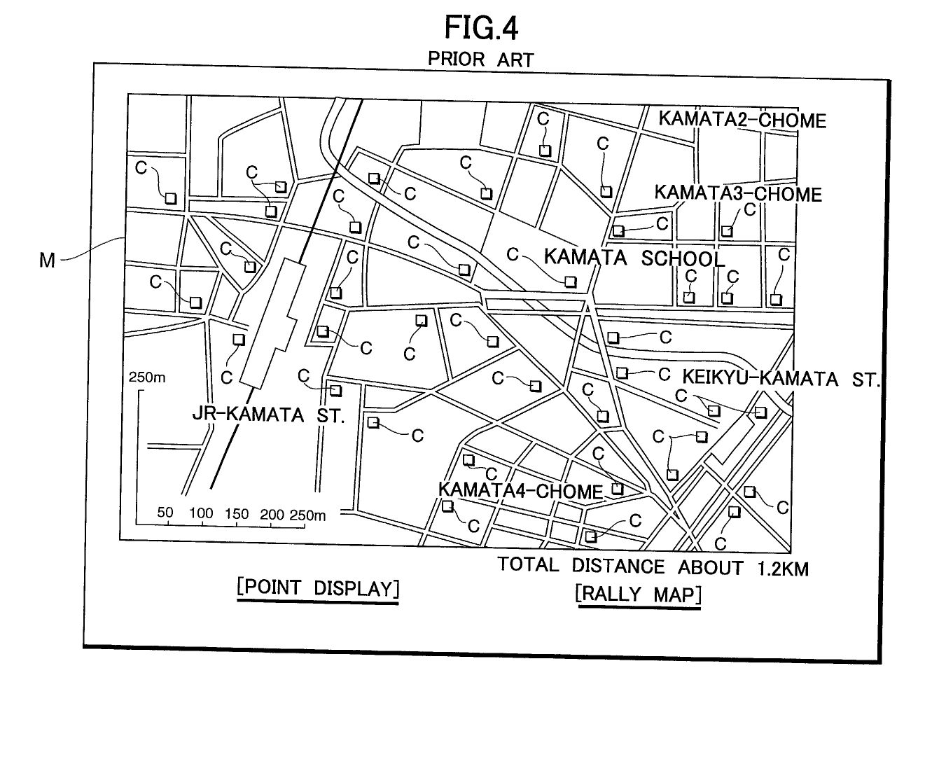

### DETAILED DESCRIPTION OF THE PREFERRED EMBODIMENT

Most preferred embodiment according to present invention will be described below in detail with reference to the accompanying drawings.

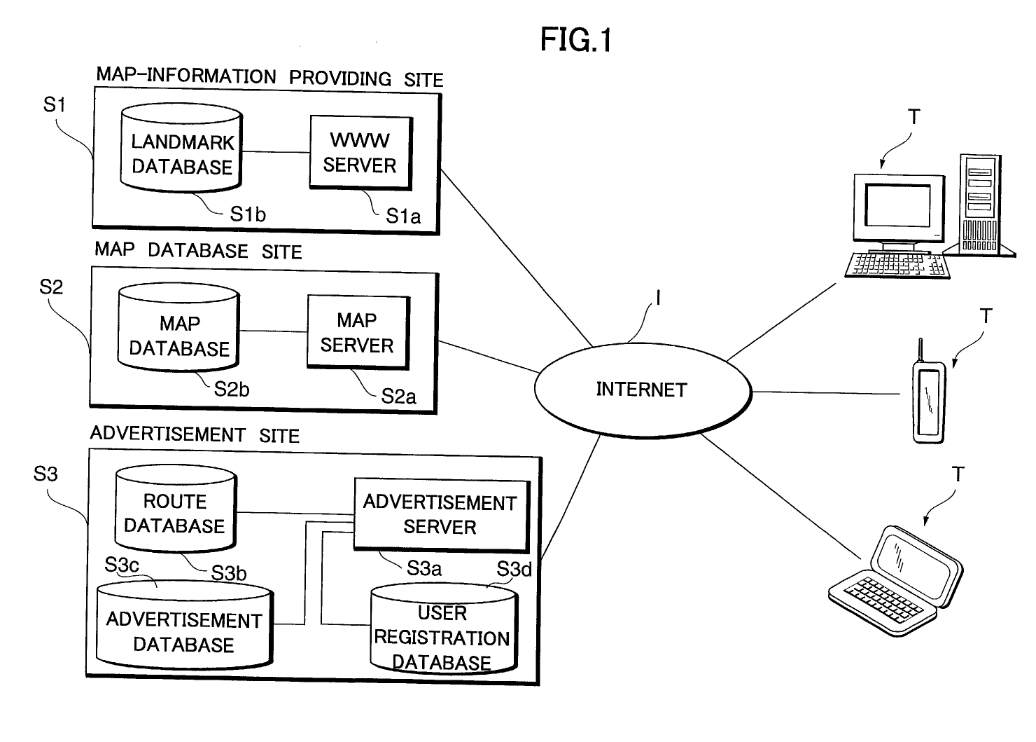

FIG. 1 is a system block diagram showing an example of an embodiment of an advertisement display system in a map-information providing service according to the present invention.

In FIG. 1, a map-information providing site S1, a map database site S2 and an advertisement site S3 are individually connected to the Internet. A user terminal T such as a personal computer, a mobile telephone and PDA (Personal Digital Assistants) connects via the public switched phone network (not shown), an access server (not shown) and the Internet I to each of the map-information providing site S1, the map database site S2 and the advertisement site S3.

The map-information providing site S1 performs a service of providing the map information by means of WWW (World Wide Web), and exercises control over the providing of information with the terminal T from the map database site S2 and the advertisement site S3, described later.

The map-information providing site S1 includes a WWW server S1a and a landmark database S1b storing address information, landmarks of facilities and so on and data for showing the position information of the landmarks. The WWW server S1a, as described later, accesses the landmark database S1b based on the input information from the user terminal T to specify the address, the landmark of facility or the like from the input position information and to acquire the corresponding position information from the specified landmark.

The map database site S2 performs a retrieval display service of the map information on the Internet, and includes a map server S2a reading out map image data and sending it to the user terminal T, and a map database S2b storing position information representing coordinates of a latitude and a longitude, display information about a map of a scale, a map size and so on, and image data of the map corresponding to these informations.

The advertisement site S3 sets a route desired by the user (e.g. a shortest route between a departure point and a destination point designated by the user, a route through a shopping center) on a map image displayed on the user terminal T, and displays advertisements along the set route. The advertisement site S3 includes an advertisement server S3a storing a program for setting a route and a program for retrieving advertisements meeting predetermined conditions along the set route and displaying it on the map image, a route database S3b storing vector data for showing roads on the map required for setting the route in the advertisement server S3a, an advertisement database S3c storing registered data of advertisements of advertisers such as shops and shop associations, and a user registration database S3d storing data of profiles of the users.

The route database S3b of the advertisement site S3 stores all information on roads, for example, data of roads required for setting a route various kinds of road, such as regular roads, vehicle only streets and pedestrian only streets.

The advertiser database S3c stores registration data about the advertisements of the advertiser such as a shop and a shop association, with position data on map images.

The user registration database S3d stores information which is registered in advance by each user using the map-information providing service, for example, data about a user's profile, such as a sex, age, hobby, favorite, for each user.

The user terminal T uses an application program referred as a WWW browser to receive a service of the WWW.

Next, form of the advertisement display by the above advertisement display system would be explained.

A user desiring a map-information providing service enters a URL (Uniform Resource Locator) of the map-information providing site S1 in the WWW browser installed in the user terminal T, to connect to the map-information providing site S1 via the public switched phone network, an access server and the Internet I. The map-information providing site S1 sends an HTML (Hyper Text Markup Language) text based image of a WWW page for providing the map information to the connecting user terminal T and display it thereon.

Then the user enters the conditions required for setting a route such as a departure point, a destination and others on the displayed WWW page. In the map-information providing site S1, then, based on the information of the departure point and destination point designated on the user terminal T, the WWW server S1a acquires the position (coordinate) information including the designated departure point and destination point from the landmark database S1b, and creates an HTML text showing URLs of the map database site S2 having the position (coordinate) information and data of the corresponding map image and the advertisement site S3, and transmits the HTML text to the terminal T.

The user terminal T then connects to the map database site S2 and the advertisement site S3 based on the information received from the map-information providing site S1.

Responding to a connection from the user terminal T, the map database site S2 allows the map server S2a to read out the map data of the area corresponding to the position information sent from the map-information providing site S1 to the user terminal T from the map database S2b and send it to the user terminal T.

In the advertisement site S3 ,the advertisement server S3a reads out the data about the road connecting between the departure point and the destination point designated on the user terminal T from the route database S3b, and set a route matching the condition (e.g. the shortest route) specified by the user among the routes connecting between the departure point and the destination point which are designated by the user, and then sends the resulting route data to the user terminal T. The advertisement server S3a also reads out advertisement data of the advertiser situated along the set route from the advertisement database S3c, and sends the advertisement data with the position data to the user terminal T.

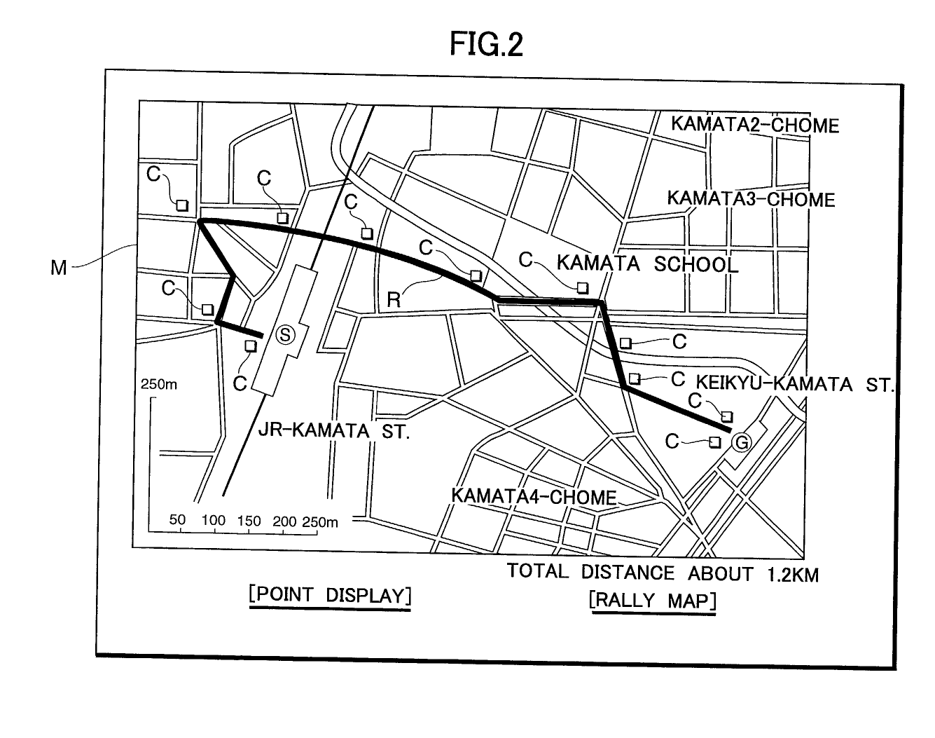

In this way, as illustrated in FIG. 2, on the user terminal T, a map image M of the area desired by the user is displayed on the WWW page displayed on the user terminal T based on the map image data sent from the map database site S2. Further, a set route R connecting between the departure point and the destination point is displayed on the displayed map image M based on the route data sent from the advertisement site S3 by means of coloring (applying colors on the roads).

Additionally, on the map image M displayed on the WWW page on the user terminal T, icons C representing the advertisements based on the advertisement data sent from the advertisement site S3 are displayed along the set route R by the position data.

Hence, the number of icons C representing the advertisements displayed on the map screen displayed on the user terminal T is significantly reduced in comparison with that in the conventional system. Since the only advertisements of the advertiser situated along the route through which the user is going to pass, it is possible for the user to immediately find useful advertisements.

In the above description, when the user enters the departure and destination points for setting the route and other conditions, the map image of the desired area is displayed on the user terminal T based on the map image data having previously read out from the map database site S2. Then, the conditions for setting the route may be entered by means of designating the departure and destination points on the displayed map image, or the like.

In the foregoing description, the user previously registers his/her profile such as a sex, age, hobbies and favorites, in the user registration database S3d of the advertisement site S3 to allow the user terminal T to display the only advertisement useful to the user along the set route.

Put another way, when the user enters the conditions for setting the route on the WWW page displayed on the user terminal T, upon inputting ID or a password, in the advertisement site S3, the advertisement server S3a reads out the data on the user's profile previously registered from the user registration database S3d based on the input ID or password.

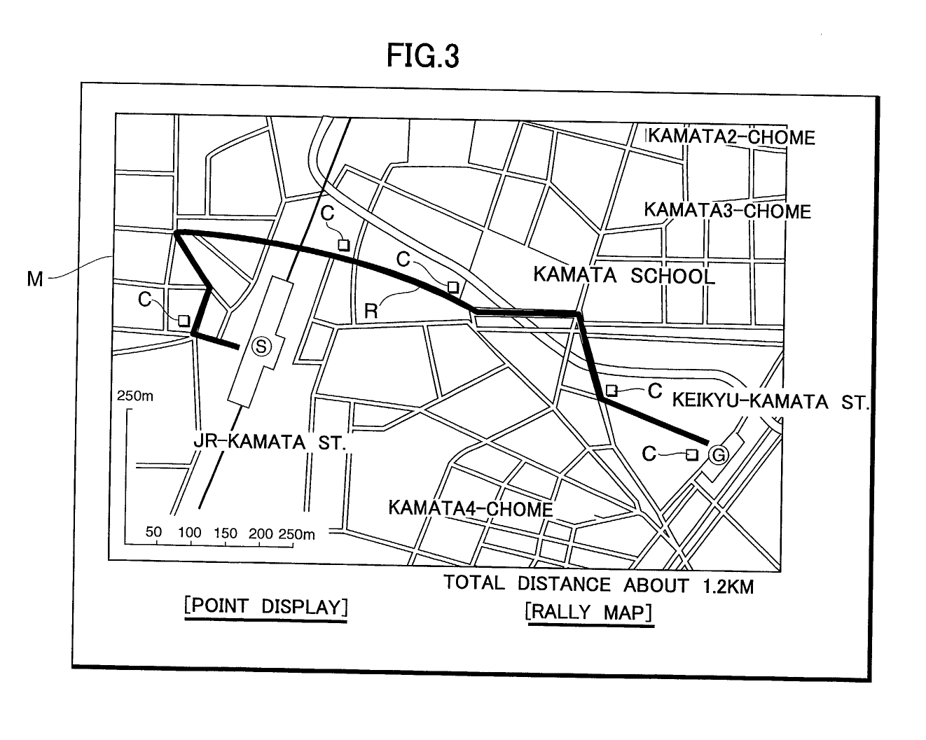

When the advertisement data of the advertiser situated along the set route is read out from the advertisement database S3c, advertisements matching the user's profile, for example, only advertisement data of boutiques, cosmetics stores and so on if the user is a young woman, is further selected and read out from the advertisement data of the advertisers situated along the set route. Then, as illustrated in FIG. 3 ,the advertisements based on the finally read-out advertisement data are displayed along the set route R.

The foregoing explanation has been made for the case where the user's profile for retrieving the advertisement to be displayed is previously registered for the advertisement database S3c.

However, as in the above case, even when the user enters his/her profile on the user terminal T at the same time when the route setting conditions are entered, the advertisement server S3c also retrieves the advertisement data to be displayed on the user terminal T from the advertisement database S3c based on the entered user's profile.

Thus, the advertisements to be displayed along the set route on the map image on the user terminal T are retrieved based on the user's profile. For this reason, the only advertisements useful to the user are displayed on the map image.

The terms and description used herein are set forth by way of illustration only and are not meant as limitations. Those skilled in the art will recognize that numerous variations are possible within the spirit and scope of the invention as defined in the following claims.

What is claimed is:

1. A advertisement display system in a map-information providing service transmitting map-image data to a user terminal to display a map image based on the map-image data, and displaying advertisements on the displayed map image, comprising:
an advertisement site for displaying the advertisements on the map image displayed on said user terminal, including a advertisement server for displaying a route setting and advertisements situated along the set route on the map image, a route database storing road data on a map required for setting a route in said advertisement server, and advertisement database storing registered advertisement data,
wherein said advertisement server sets a route based on the road data stored in said route database, and read out advertisements situated along the set route from said advertisement database to display them on the user terminal.

2. The advertisement display system in a map-information providing service according to claim 1, wherein said advertisement server reads out only advertisements, matching a profile of a user, of said advertisements situated along the set route from said advertisement database based on the data representing the profile of the user sent from the user terminal, and displays them on the user terminal.

3. The advertisement display system in a map-information providing service according to claim 1, wherein said advertisement site further includes a user registration database storing registration data representing the profile of the user, wherein said advertisement server reads out the only advertisement, matching the profile of the user, of said advertisements situated along the set route from said advertisement database based on the registration data of the user read from the user registration database, and displays them on the user terminal.
